(19) United States
(12) Patent Application Publication
(10) Pub. No.: US 2008/0047721 A1
(43) Pub. Date: Feb. 28, 2008

(54) PRESSURE REGULATING MECHANISM FOR PNEUMATIC TOOL AND PNEUMATIC TOOL COMPRISING THE SAME

(75) Inventors: Hsin-Chi Chen, Taiping City (TW); Wu-Chuan Chang, Taichung (TW)

Correspondence Address: PAI PATENT & TRADEMARK LAW FIRM, 1001 FOURTH AVENUE, SUITE 3200, SEATTLE, WA, 98154, US

(73) Assignee: TRANMAX MACHINERY CO., LTD., Taiping City (TW)

(21) Appl. No.: 11/535,149

(22) Filed: Sep. 26, 2006

(30) Foreign Application Priority Data
Aug. 23, 2006 (TW) 95131045

(51) Int. Cl. B23Q 5/00

(52) U.S. Cl. 173/15; 137/102

(57) ABSTRACT

A pressure regulating mechanism for use in a pneumatic tool includes a first relief valve and a second relief valve. The pneumatic tool includes a housing having an air intake passage, an exhaust passage and a connecting passage in air communication between the air intake passage and the exhaust passage, an air cylinder unit mounted in the housing. The air cylinder unit has an air chamber, an air passage in air communication between the air chamber and the air intake passage, and a through hole in air communication with the air passage. The first relief valve is for mounting in the connecting passage adjacent to the air cylinder unit. The second relief valve is for mounting in the through hole of the air cylinder unit. The pressure regulating mechanism maintains the air pressure inside the pneumatic tool stable.

### BACKGROUND OF THE INVENTION

1. Field of the Invention

The present invention relates to a pneumatic tool and more particularly to a pneumatic tool having a pressure regulating mechanism.

2. Description of the Related Art

A conventional pneumatic tool directly uses compressed air to drive the tool element. A pneumatic tool using easily obtained air as its power source does not cause pollution during operation. Further, a pneumatic tool can be operated in a wet operating environment. Furthermore, maintenance of the parts of a pneumatic tool is easy. Because of the aforesaid advantages, pneumatic tools are commonly used in many different industries.

When a user connects a pneumatic tool having a van wheel to a source of compressed air and presses the button of the pneumatic tool to let compressed air enter the pneumatic tool, the intake flow of compressed air forces the van wheel to rotate, thereby causing a transmission mechanism to produce a torque or impact force for different applications. However, if the air pressure of supplied compressed air is excessively high, the van wheel may be rotated too fast, or the output torque may be excessively high, thereby causing damage to tool parts or shortening the working life of the tool.

U.S. Pat. No. 4,834,131 discloses a safety system for automatically preventing over pressure in the interior of a pneumatically operated tool supplied with a source of compressed air. This safety system includes a safety relief valve detachably connected between the tool and the compressed air source. The safety valve includes a hollow housing having a relief port therein and a resettable valve member is mounted in the housing and movable to open and close the relief port in response to the level of air pressure supplied from the source of compressed air. A biasing spring is mounted on the valve member for maintaining an inner end of the member in engagement with the stop until an over pressure is encountered and when this occurs, the excessive air pressure becomes effective to move the valve member outwardly to open the relief port. Once the over pressure no longer exists, the biasing spring is again effective to reseat the valve and close the relief port so that tool operation may be continued.

According to the aforesaid prior art design, the safety relief valve is detachably connected between the tool and the compressed air source. When this safety system is used in a pneumatic tool having the aforesaid van wheel, the safety relief valve of the safety system is kept away from the van wheel at a long distance, and the air pressure that passed the safety system may not be accurately maintained within the effective range capable of driving the van wheel. Further, if the pneumatic tool provides a multi-step speed changing function, the safety system cannot regulate the air pressure to fit different speeds.

Therefore, it is desirable to provide a pneumatic tool that does not have the aforesaid drawbacks.

### SUMMARY OF THE INVENTION

The present invention has been accomplished under the circumstances in view. It is an objective of the present invention to provide a pressure regulating mechanism for pneumatic tool, which can control the internal air pressure of the pneumatic tool more accurately.

It is another objective of the present invention to provide a pressure regulating mechanism for pneumatic tool, which can control and adjust the air pressure according to different operation speeds of the pneumatic tool.

To achieve these objectives of the present invention, a pressure regulating mechanism provided by present invention is for use in a pneumatic tool. The pneumatic tool has a housing and an air cylinder unit. The housing has an air intake passage, an exhaust passage and a connecting passage in air communication between the air intake passage and the exhaust passage. The air cylinder unit has an air chamber, an air passage in air communication with the air chamber and the air intake passage, and a through hole in air communication with the air passage of the air cylinder unit. The pressure regulating mechanism comprises a first relief valve for mounting in the connecting passage adjacent to the air cylinder unit, and a second relief valve for mounting in the through hole of the air cylinder unit. The pressure regulating mechanism keeps the air pressure inside the pneumatic tool stable. Further, for the pneumatic tool provided with a multi-step speed changing function, the pressure regulating mechanism can control the air pressure accurately to fit different speeds and to further keep the torque produced by the pneumatic tool at a uniform rate at every speed by means of different positioning of the relief valves.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an exploded view of a pneumatic tool according to a preferred embodiment of the present invention;

FIG. 2 is an enlarged view of a part of FIG. 1;

FIG. 3 is a sectional view of the pneumatic tool according to the preferred embodiment of the present invention;

FIG. 4 is similar to FIG. 3, but showing the first relief valve opened;

FIG. 5 is similar to FIG. 3, but showing the second relief valve opened;

FIG. 6 is a sectional view taken along line 6-6 of FIG. 4, showing the adjustment member rotated to a low-speed position;

FIG. 7 is a sectional view taken along line 7-7 of FIG. 5, showing the adjustment member rotated to a high-speed position; and

FIG. 8 is similar to FIG. 7, but showing the adjustment member rotated to a reverse-rotation position.

### DETAILED DESCRIPTION OF THE INVENTION

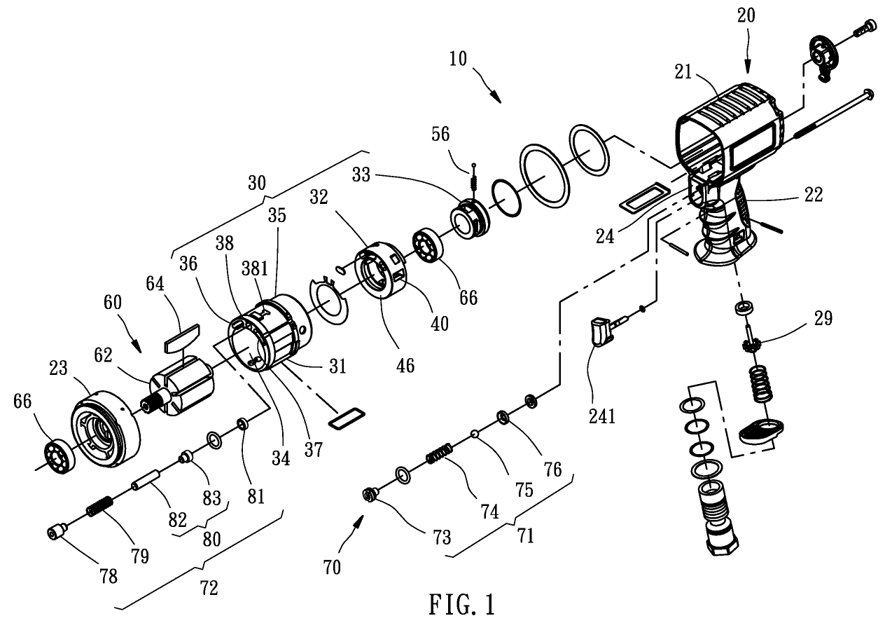

As shown in FIG. 1, a pneumatic tool 10, which is embodied as a pneumatic wrench in accordance with a preferred embodiment of the present invention for illustrative purpose, comprises a housing 20, an air cylinder unit 30, a rotating device 60, and a pressure regulating mechanism 70.

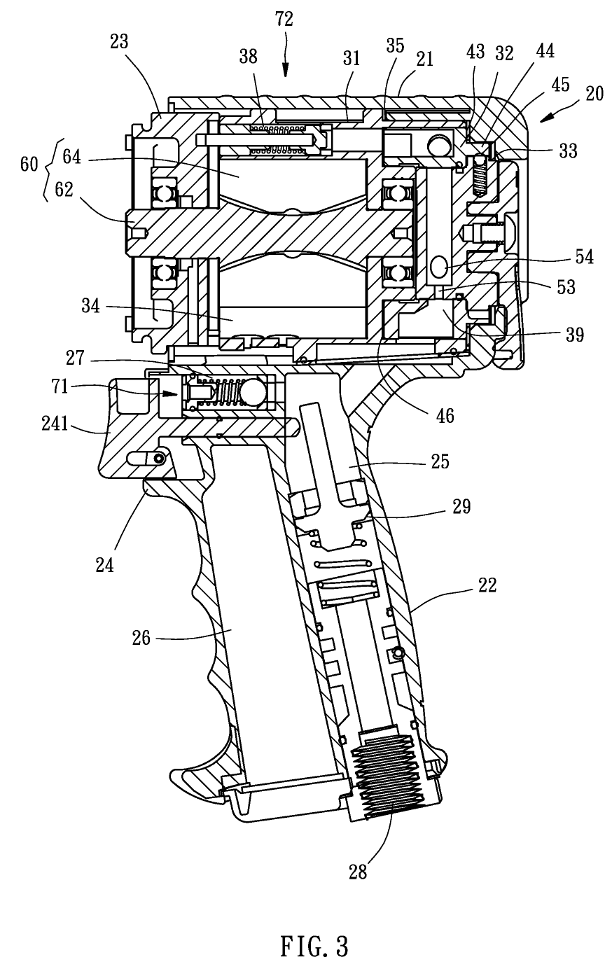

As shown in FIGS. 1 and 3, the housing 20 has a head 21 and a handle 22. The head 21 is a hollow shell, which is hermetically sealable by an end cap 23. The handle 22 extends from the periphery of the housing 20 and has a button-receiving portion 24 disposed adjacent to the head 21. The handle 22 defines in the inside thereof an air intake passage 25, an exhaust passage 26, and a connecting passage 27. The air intake passage 25 has one end terminating in an air inlet 28 on the bottom side of the handle 22, and the other end extending to the inside of the head 21. A switch valve 29 is installed in the air intake passage 25 to control the flowing of compressed air into the housing 20. The exhaust passage 26 is disposed in front of the air intake passage 25. The connecting passage 27 is defined inside the button-receiving portion 24 in air communication between the air intake passage 25 and the exhaust passage 26.

As shown in FIGS. 1-3 and 6, the air cylinder unit 30 comprises an air cylinder 31, a valve plug 32, and an adjustment member 33. The air cylinder 31 is a cylindrical member, having an air chamber 34 recessed inwardly from one end thereof, namely, the front end, and an annular flange 35 backwardly extending around the periphery of the other end thereof, namely, the rear end. The air cylinder 31 further has a smoothly arched first air hole 36 and a smoothly arched second air hole 37 on the front end around the air chamber 34, a through hole 38 on the front end between the first air hole 36 and the second air hole 37, and a T-slot 381 on the periphery of the air cylinder 31 in air communication with the through hole 38.

The valve plug 32 is an annular member, which has one air inlet 39 and two air outlets 40 radially cut through the inner and outer walls thereof, a first air guide hole 41 and a second air guide hole 42 radially cut through the inner and outer walls thereof and spacedly disposed between the two air outlets 40, a positioning portion 44 formed by an annular flange integrally extending from the rear end face 43 of the valve plug 32, a plurality of recesses 45 spacedly provided at the inner wall of the positioning portion 44, a smoothly arched first air hole 47 and a smoothly arched second air hole 471 on the front end face 46 of the valve plug 32, and an air passage 48 in air communication between the first air hole 47 and the first air guide hole 41. Further, the second air guide hole 42 is in air communication with the second air hole 471.

As shown in FIG. 3, the valve plug 32 is mounted within the annular flange 35 of the air cylinder 31 and stopped with the front end face 46 against the air cylinder 31, keeping the first air hole 47 in air communication with the first air hole 36 of the air cylinder 31 and the through hole 38, the second air hole 471 in air communication with the second air hole 37 of the air cylinder 31, and the air inlet 39 in air communication with the air intake passage 25 of the housing 20.

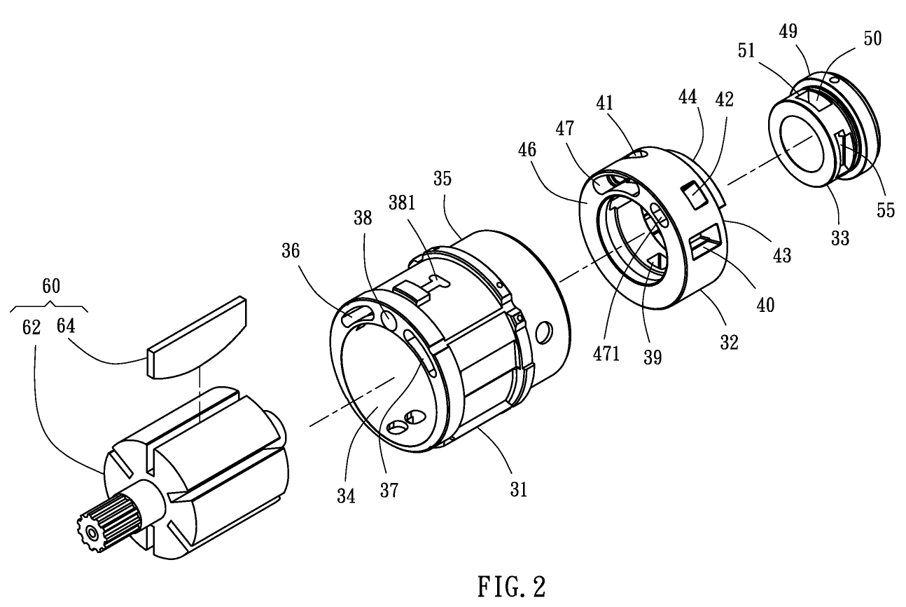

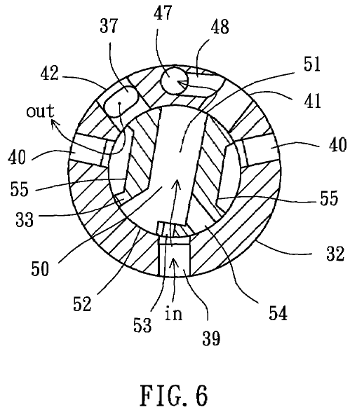

As shown in FIGS. 2 and 6, the adjustment member 33 is an annular member having a flange 49 extending around the periphery, a radial adapter passage 50 defining a first through hole 51 at one end thereof and a second through hole 52 obliquely extending to the periphery of the adjustment member 33 at the other end thereof, a third through hole 53 of relatively smaller diameter and a fourth through hole 54 of relatively greater diameter respectively extending to the radial adapter passage 50, two grooves 55 on the periphery at two opposite sides, and a steel ball type positioning device 56 protruded over the periphery of the flange 49.

As shown in FIGS. 6-8, the adjustment member 33 is provided at the center of the valve plug 32 and peripherally disposed in contact with the inner wall of the valve plug 32 in an air tight manner and rotatable relative to the valve plug 32. When the adjustment member 33 is rotated, the positioning device 56 is moved along the inner wall of the positioning portion 44 from one recess 45 to another, i.e., the positioning device 56 can be selectively positioned in one of the recesses 45 to hold the adjustment member 33 in a specific angular position and to further control the connection status between the radial adapter passage 50 and the air guide holes 41 and 42 and the flowrate of air into the air cylinder 31. By means of controlling the flowrate of air into the air cylinder 31, the pneumatic tool provides a multi-step speed changing function.

The rotating device 60 comprises a shaft 62 supported on two axle bearings 66 inside the air chamber 34 of the air cylinder 31, and a plurality of blades 64 radially arranged around the periphery of the shaft 62 and suspended in the air chamber 34 inside the air cylinder 31. When compressed air passes through the air hole 36 or 37 into the air chamber 34, the rotating device 60 is forced to rotate in the air cylinder 31 by the intake flow of compressed air, thereby causing a transmission mechanism (not shown) to output a torque or impact force. Since the transmission mechanism is of the known art, no further detailed description in this regard is necessary.

Referring to FIG. 1 again, the pressure regulating mechanism 70 comprises a first relief valve 71 and a second relief valve 72. The first relief valve 71 comprises a base member 73, a spring 74, a valve element 75, and a bushing 76. The valve element 75 is a steel ball. The second relief valve 72 comprises a base member 78, a spring 79, a valve element 80, and a bushing 81. The valve element 80 has a shank 82 and a stopper 83 at one end of the shank 82.

As shown in FIG. 3, the first relief valve 71 is mounted in the connecting passage 27 inside the housing 20, keeping the base member 73 adjacent to the button 241 movably received in the button-receiving portion 24 and the bushing 76 aimed at the air intake passage 25. The spring 74 of the first relief valve 71 is supported between the base member 73 and the valve element 75. The spring force of the spring 74 pushes the valve element 75 toward the bushing 76 to control the communication status between the connecting passage 27 and the air intake passage 25. The second relief valve 72 is mounted in the through hole 38 of the air cylinder 31, keeping the base member 78 adjacent to the front side of the air cylinder 31 and the stopper 83 of the valve element 80 aimed at the valve plug 32. The spring 79 of the second relief valve 72 is sleeved onto the shank 82 and supported between the base member 78 and the stopper 83. The spring force of the spring 79 pushes the valve element 80 toward the bushing 81 to control the communication status between the through hole 38 of the air cylinder 31 and the first air hole 47.

As shown in FIG. 6, when compressed air of a predetermined pressure is guided into the air inlet 28 of the pneumatic tool 10 and the button 241 of the button-receiving portion 24 is operated to switch on the switch valve 29, compressed air goes through the air intake passage 25 into the air inlet 39 of the valve plug 32 and the third through hole 53 and radial adapter passage 50 of the adjustment member 33, and then goes in proper order through the first through hole 51, the first air guide hole 41, the air passage 48 and the first air hole 47 into the first air hole 36 of the air cylinder 31 to rotate the rotating device 60 forwards. Thereafter, compressed air goes through the second air hole 37 of the air cylinder 31, the second air hole 471 of the valve plug 32, the second air guide hole 42 and the grooves 55, and then goes out of the air outlets 40. As shown in FIG. 8, when the adjustment member 33 is rotated to have the second through hole 52 in air communication with the air inlet 39 of the valve plug 32, compressed air goes through the second air guide hole 42 and the second air hole 471 into the second air hole 37 of the air cylinder 31 to rotate the rotating device 60 in the reversed direction. Thereafter, compressed air goes through the first air hole 36 of the air cylinder 31, the first air hole 47 of the valve plug 32, a first air guide hole 41 and the grooves 55, and then goes out of the air outlets 40.

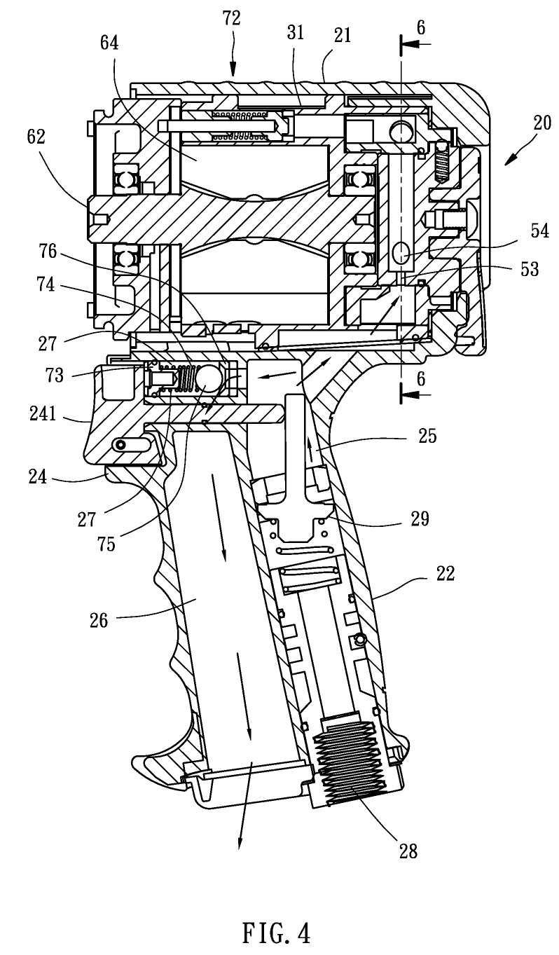

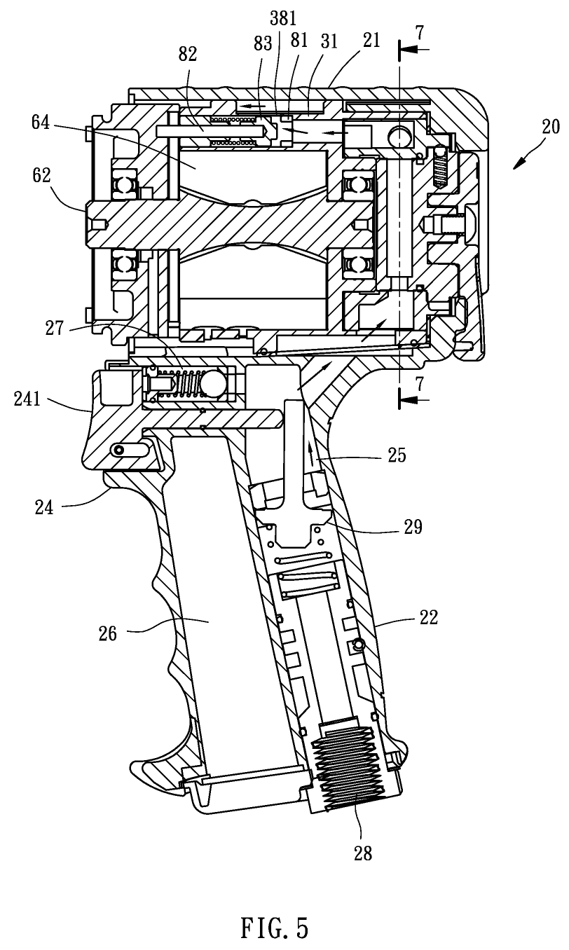

When the adjustment member 33 is in the position shown in FIG. 6, only the third through hole 53 of relatively smaller diameter is in air communication with the air inlet 39, and therefore the flowrate of compressed air that passes into the radial adapter passage 50 is low. When compressed air goes through the radial adapter passage 50 into the first air guide hole 41, the air passage 48 and the first air hole 47, it simultaneously goes through the first air hole 36 of the air cylinder 31 and the second relief valve 72 into the first air hole 36 to rotate the rotating device 60 forwards at a low speed without moving the valve element 80 of the second relief valve 72. In case the air pressure of compressed air passing to the air intake passage 25 surpassed a nominal pressure, compressed air will not fully go through the third through hole 53 of the adjustment member 33, and a great back pressure is produced around the air inlet 39 of the valve plug 32, as shown in FIG. 4, and the back pressure thus produced pushes the valve element 75 of the first relief valve 71 away from the associated bushing 76 to open the passage between the connecting passage 27 and the air intake passage 25 for allowing a part of compressed air to pass through the connecting passage 27 into the exhaust passage 26 so as to keep the air pressure of compressed air passing through the air intake passage 25 and the valve plug 32 within the nominal pressure.

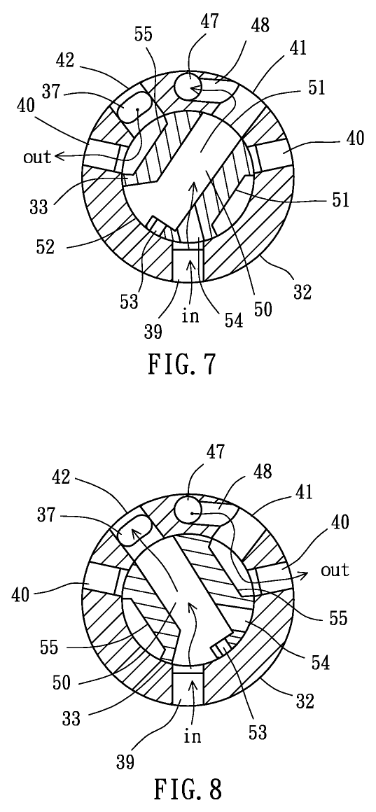

Referring to FIG. 7, when the adjustment member 33 is rotated to the position where the fourth through hole 54 of relatively greater diameter is in communication with the air inlet 39 of the valve plug 32, the flowrate of compressed air that passes through the fourth through hole 54 into the radial adapter passage 50 is higher. At this time, compressed air goes in proper order through the radial adapter passage 50, the first through hole 51, the first air guide hole 41, the air passage 48, the first air hole 47, and the first air hole 36 of the air cylinder 31 to rotate the rotating device 60 at a higher speed. Because of the flowrate of compressed air, which is allowed to pass through the air inlet 39 of the air plug 32, is higher at this situation, the back pressure thus produced is relatively smaller. Therefore, when compressed air of pressure surpassing the nominal pressure goes into the air intake passage 25, the back pressure thus produced is not enough to move the valve element 75 of the first relief valve 71, however it goes through the first air hole 47 of the valve plug 32 to push the valve element 80 of the second relief valve 72 away from the associated bushing 81, and therefore the through hole 38 is in air communication with the first air hole 47 for allowing a part of compressed air to pass through the through hole 38 and the T-slot 381 to the outside of the air cylinder 31 until the air pressure in the air cylinder 31 returns to the nominal pressure range.

By means of the aforesaid pressure regulating mechanism in the pneumatic tool, the air pressure inside the pneumatic tool is maintained within a relatively stable range. Further, by means of different positioning of the relief valves of the pressure regulating mechanism, the pneumatic tool provides a multi-step speed changing function, and the pressure regulating mechanism controls the air pressure accurately to fit different speeds. When the air pressure surpasses the set level, the pressure regulating mechanism automatically regulates the air pressure, so as to keep the torque produced by the pneumatic tool at a uniform rate at every speed.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A pneumatic tool comprising:
a housing having an air intake passage, an exhaust passage, and a connecting passage in air communication between the air intake passage and the exhaust passage;
an air cylinder unit mounted inside the housing and provided with an air chamber and an air passage in air communication between the air chamber and the air intake passage of the housing;
a rotating device rotatably mounted in the air chamber of the air cylinder unit; and
a first relief valve mounted in the connecting passage of the housing adjacent to the air cylinder unit.

2. The pneumatic tool as claimed in claim 1, further comprising a second relief valve mounted in a through hole of the air cylinder unit, wherein the through hole of the air cylinder unit is in air communication with the air passage of the air cylinder unit.

3. The pneumatic tool as claimed in claim 2, wherein the first relief valve and the second relief valve each comprise a base member, a valve element, a bushing, and a spring connected between the base member and the valve element for pushing the valve element toward the bushing.

4. The pneumatic tool as claimed in claim 3, wherein at least one of the valve elements of the first and second relief valves has a shank and a stopper at one end of the shank; the spring of the respective relief valve is sleeved onto the shank and stopped between the associated base member and the stopper of the associated valve element.

5. The pneumatic tool as claimed in claim 1, wherein the housing comprises a handle and a button-receiving portion provided at the handle; the connecting passage is defined in the button-receiving portion.

6. The pneumatic tool as claimed in claim 2, wherein the air cylinder unit comprises an air cylinder provided with said air chamber, said through hole and an air hole in air communication with said through hole, a valve plug provided with said air passage, and an adjustment member having an adapter passage; wherein the valve plug is mounted in the air cylinder to have the air passage of the air cylinder unit be in air communication with the through hole and the air hole of the air cylinder; wherein the adjustment member is rotatably mounted in the valve plug to have the adapter passage be in air communication with the air passage of the air cylinder unit and the air intake passage of the housing.

7. A pneumatic tool comprising:
a housing having an air intake passage;
an air cylinder unit mounted inside the housing and provided with an air chamber, an air passage in air communication with the air chamber, and a through hole in air communication with the air passage to outside of the air cylinder unit; wherein the air passage and the through hole are in air communication with the air intake passage;
a rotating device rotatably mounted in the air chamber of the air cylinder unit; and
a second relief valve mounted in the through hole of the air cylinder unit.

8. The pneumatic tool as claimed in claim 7, wherein the housing has an exhaust passage and a connecting passage in air communication between the air intake passage and the exhaust passage; wherein the pneumatic tool further comprises a first relief valve mounted in the connecting passage adjacent to the air cylinder unit.

9. The pneumatic tool as claimed in claim 8, wherein the first relief valve and the second relief valve each comprise a base member, a valve element, a bushing, and a spring connected between the base member and the valve element for pushing the valve element toward the bushing.

10. The pneumatic tool as claimed in claim 9, wherein at least one of the valve elements of the first and second relief valves has a shank and a stopper at one end of the shank; the spring of the respective relief valve is sleeved onto the shank and stopped between the associated base member and the stopper of the associated valve element.

11. The pneumatic tool as claimed in claim 8, wherein the housing comprises a handle and a button-receiving portion provided at the handle; and the connecting passage is defined in the button-receiving portion.

12. The pneumatic tool as claimed in claim 7, wherein the air cylinder unit comprises an air cylinder provided with said air chamber, said through hole and an air hole in air communication with said through hole, a valve plug provided with said air passage, and an adjustment member having an adapter passage; wherein the valve plug is mounted in the air cylinder to have the air passage of the air cylinder unit be in air communication with the through hole and the air hole of the air cylinder; wherein the adjustment member is rotatably mounted in the valve plug to have the adapter passage be in air communication with the air passage of the air cylinder unit and the air intake passage of the housing.

13. A pressure regulating mechanism for use in a pneumatic tool having a housing and an air cylinder unit, the housing having an air intake passage and a connecting passage in air communication with the air intake passage and the atmosphere, the air cylinder unit having an air chamber, an air passage in air communication with the air chamber and the air intake passage, and a through hole in air communication with the air passage of the air cylinder unit, the pressure regulating mechanism comprising:
a first relief valve for mounting in the connecting passage adjacent to the air cylinder unit; and
a second relief valve for mounting in the through hole of the air cylinder unit.

14. The pressure regulating mechanism as claimed in claim 13, wherein the first relief valve and the second relief valve each comprise a base member, a valve element, a bushing, and a spring connected between the base member and the valve element for pushing the valve element toward the bushing.

15. The pressure regulating mechanism as claimed in claim 13, wherein the air cylinder unit comprises an air cylinder provided with said air chamber, said through hole and an air hole in air communication with said through hole, a valve plug provided with said air passage, and an adjustment member having an adapter passage; wherein the valve plug is mounted in the air cylinder to have the air passage of the air cylinder unit be in air communication with the through hole and the air hole of the air cylinder; wherein the adjustment member is rotatably mounted in the valve plug to have the adapter passage be in air communication with the air passage of the air cylinder unit and the air intake passage of the housing.
